(19) United States
(12) Patent Application Publication
(10) Pub. No.: US 2026/0142719 A1
(43) Pub. Date: May 21, 2026

(54) Variable Delay Cellular Network Timing Synchronization

(71) Applicant: DISH Wireless L.L.C., Littleton, CO (US)

(72) Inventors: Mehdi Alasti, Arlington, VA (US); Lin-Nan Lee, Potomac, MD (US); Khalid Al-Mufti, Sterling, VA (US); David Zufall, Littleton, CO (US); Sourabh Gupta, Ashburn, VA (US)

(21) Appl. No.: 18/951,217

(22) Filed: Nov. 18, 2024

(51) Int. Cl. H04B 7/185; H04J 3/06; H04W 56/00

(52) U.S. Cl. CPC H04B 7/18582; H04W 56/001; H04J 3/0667

(57) ABSTRACT

Various arrangements for performing timing synchronization in a variable link propagation delay environment, such as a non-terrestrial cellular network system, are presented. A master clock system and slave clock system can exchange timing messages. Wireless communication can be used for communication between the slave clock system and the master clock system. A correction factor, which can be based at least in part of ephemeris data, can be calculated. This correction factor can then be used in determining an offset between the master and slave clock systems.

### BACKGROUND

The Precision Time Protocol (PTP) is a network-based protocol that allows for clocks remote from each other to be synchronized with high precision and accuracy accounting for a fixed amount of link propagation delay present between the clocks. Therefore, as long as the link propagation delay is consistent, PTP can establish synchronized clocks that are remote from each other. However, situations exist where the link propagation delay may be variable. In such scenarios, PTP may not sufficiently synchronize two or more clocks.

### SUMMARY

Various embodiments are described related to a non-terrestrial cellular network system. In some embodiments, a non-terrestrial cellular network system is described. The system may comprise a radio unit (RU) located on a satellite configured to orbit the earth. The system may comprise a slave clock system, comprising a slave clock, located on the satellite, that performs timing for the RU. The system may comprise a distributed unit (DU), located at a ground station. The ground station may communicate wirelessly with the satellite. The system may comprise a satellite gateway system, comprising a master clock system. The master clock system may be configured to transmit a first timing message to the slave clock system. The first timing message may comprise a first timestamp indicative of a first transmission time. The master clock system may be configured to receive a second timing message from the slave clock system. The master clock system may be configured to record a first reception time at which the second timing message was received from the slave clock system. The master clock system may be configured to calculate a correction factor for the slave clock system located on the satellite. The master clock system may be configured to transmit a third timing message to the slave clock system that may indicate the calculated correction factor and the first reception time.

Embodiments of such a system may include one or more of the following features: the correction factor may be based on ephemeris data for the satellite. The correction factor may be based on a difference in an amount of link propagation delay for the second timing message and the first timing message. The slave clock system may be configured to record a second reception time at which the first timing message was received. The slave clock system may be configured to record a second transmission time at which the second timing message was transmitted by the slave clock system. The slave clock system may be further configured to calculate a timing offset between the slave clock and the master clock system based on: the correction factor, the first transmission time, the second transmission time, the first reception time, and the second reception time. The slave clock system may be further configured to update timing for the RU based on the calculated timing offset. The non-terrestrial cellular network system may further comprise a second slave clock system, comprising a second slave clock, of the DU. The second slave clock may be synchronized with the master clock system using the precision timing protocol (PTP). The master clock system may be further configured to adjust the correction factor using a trained machine learning model. The master clock system being configured to calculate the correction factor for the RU located on the satellite may comprise the master clock system being configured to calculate a first link propagation delay for the first timing message from the master clock system to the slave clock system on the satellite based on the ephemeris data. The system may be configured to calculate a second link propagation delay for the second timing message from the slave clock system on the satellite to the master clock system based on the ephemeris data. The system may be configured to calculate the correction factor based on the first link propagation delay and the second link propagation delay. The RU may be configured to relay cellular network communications between a plurality of UE and the distributed unit based on the updated timing. The RU on the satellite and the DU may be located at the satellite gateway system as part of a gNodeB in communication with a core of a 5G New Radio (NR) cellular network.

In some embodiments, a method for performing timing synchronization in a variable link propagation delay environment is described. The method may comprise transmitting, by a master clock system, a first timing message to a slave clock system. The first timing message comprises a first timestamp may be indicative of a first transmission time. The slave clock system may be remotely located from the master clock system. Wireless communication may be used for communication between the slave clock system and the master clock system. The method may comprise receiving, by the master clock system, a second timing message from the slave clock system. The method may comprise recording, by the master clock system, a first reception time at which the second timing message was received from the slave clock system. The method may comprise calculating, by the master clock system, a correction factor. The method may comprise transmitting, by the master clock system, a third timing message to the slave clock system that may indicate the calculated correction factor and the first reception time.

Embodiments of such a method may include one or more of the following features: The correction factor may be based on ephemeris data for a satellite that houses the slave clock system. The correction factor may be based on a difference in an amount of link propagation delay for the second timing message and the first timing message. The method may further comprise recording, by the slave clock system, a second reception time at which the first timing message was received. The method may further comprise recording a second transmission time at which the second timing message was transmitted by the slave clock system. The method may further comprise calculating, by the slave clock system, a timing offset between the slave clock system and the master clock system based on: the correction factor, the first transmission time, the second transmission time, the first reception time, and the second reception time. The method may further comprise updating, by the slave clock system, timing based on the calculated timing offset. The method may further comprise synchronizing, the master clock system with a second slave clock, using the precision timing protocol (PTP). Calculating the correction factor may comprise calculating a first link propagation delay for the first timing message from the master clock system to the slave clock system based on the ephemeris data. Calculating the correction factor may comprise calculating a second link propagation delay for the second timing message from the slave clock system to the master clock system based on the ephemeris data. Calculating the correction factor may comprise calculating the correction factor based on the first link propagation delay and the second link propagation delay. The slave clock system may be co-located on the satellite with a radio unit (RU) of a gNodeB and the master clock system may be co-located at a satellite gateway with a distributed unit (DU) of the gNodeB.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a multi-clock system having variable link propagation delay.

FIG. 2 illustrates an embodiment of a non-terrestrial cellular network system that includes a radio unit located on a satellite.

FIG. 3 illustrates an embodiment of a non-terrestrial cellular network system in which the PTP is used in combination with a timing synchronization arrangement for variable link propagation delay systems.

FIG. 4 illustrates an embodiment of a timing diagram for a variable link propagation delay system.

FIGS. 5A and 5B illustrate an embodiment of a method for using a timing synchronization arrangement for a variable link propagation delay system.

### DETAILED DESCRIPTION

Cellular networks, such as 5G New Radio (NR) cellular networks, can require that components have synchronized clocks with each other. In a 5G NR based cellular network, a gNodeB (gNB) includes a central unit (CU), distributed unit (DU), and a radio unit (RU). At least the DU and RU need to have clocks synchronized with each other. In some embodiments of a terrestrial cellular network, a gNB includes a DU and RU being co-located at a base station (BS) used to communicate using a radio access technology (RAT) (e.g., 5G) with various pieces of user equipments (UEs). The DU and the RU can be in communication with each other via a router. In such an embodiment, the amount of link propagation delay for communications between the DU and the RU is fixed or nearly fixed. Therefore, use of the PTP may be sufficient in order to synchronize clocks of the DU and RU.

In a non-terrestrial network (NTN), such as a 5G NR based NTN, the RU may be located on a satellite in low earth orbit (LEO) or medium earth orbit (MEO). The DU, however, may be located on the ground at a satellite gateway ground station and communicates wirelessly with the RU. Since the satellite is in LEO or MEO orbit, the satellite's position relative to the satellite gateway may be constantly changing. For example, a satellite in LEO can travel at approximately 7.8 kilometers per second (17,500 miles per hour). This high rate of travel results in the amount of link propagation delay of communications between the satellite and the satellite gateway (e.g., the DU and the RU) constantly changing. In such a scenario, the PTP may not be sufficient to synchronize clocks at the DU and RU.

As detailed herein, a high precision and accuracy timing synchronization arrangement can be used for variable link propagation delay systems. Such systems can include arrangements where the DU is located at a fixed location on the Earth, but the RU is located on a satellite in orbit. The timing synchronization arrangement detailed herein accounts for the situation where the amount of link propagation delay between the two clocks varies during the synchronization process. For example, the amount of link propagation delay during a first communication between a master clock controller and a slave clock controller can be greater or less than the amount of link propagation delay during a second communication performed a short time later between the slave clock controller and the master clock controller. For example, ephemeris data indicative of the precise location of the satellite can be used to determine with high precision the amount of link propagation delay present due to link propagation delay between a satellite and the ground station with which it is in communication.

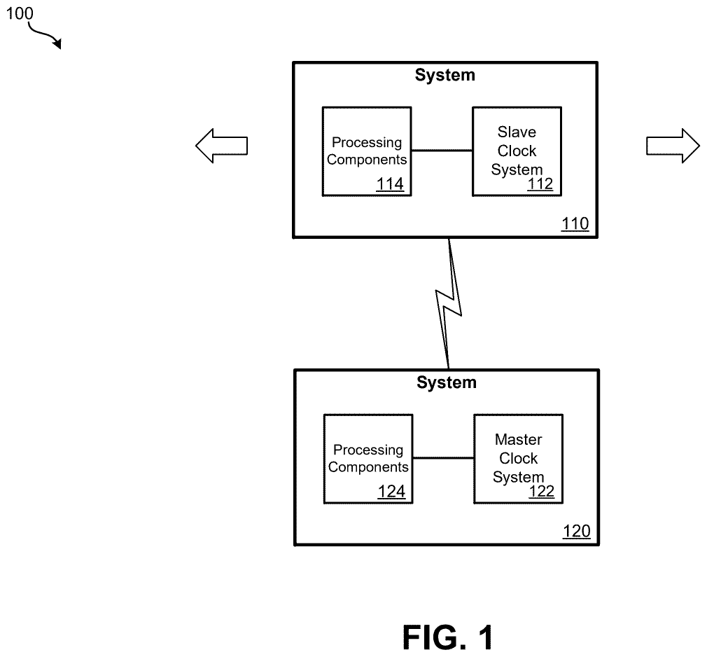

Further detail regarding these and additional embodiments is provided in relation to the figures. FIG. 1 illustrates an embodiment of a multi-clock system 100 (“system 100”) that experiences variable link propagation delay. System 100 can include system 110 and system 120 in wireless communication with each other. System 110 can include slave clock system 112 and processing components 114. System 120 can include master clock system 122 and processing components 124. System 110 and system 120 can represent any form of computerized systems that require synchronized clocks. The amount of link propagation delay between system 110 and system 120 can vary due to relative movement of system 110 or system 120 with respect to each other. As an example, system 110 may be located on a satellite, airplane, or vehicle, while system 120 may be at a fixed location on Earth. While the illustrated embodiment shows slave clock system 112 as part of the system that is physically moving, in other embodiments, master clock system 122 can be part of the moving system.

Master clock system 122 and slave clock systems 112 can each be implemented as dedicated hardware that is in communication with the respective processing components. Alternatively, master clock system 122 and slave clock system 112 can be integrated with their respective processing components such that the clock systems are at least partially implemented using firmware or software as part of the processing systems or a system-on-a-chip (SOC).

In system 100, an offset between the timing of master clock system 122 and slave clock system 112 is determined. This offset is used to adjust the timing of slave clock system 112 such that the timing output by slave clock system 112 is in synchronization with master clock system 122. Processing components 114 and 124 represent any form of computerized components that require clock synchronization with each other. For example, as detailed in this application, cellular network components, such as an RU and DU of a gNB of a 5G NR cellular network require highly synchronized clocks.

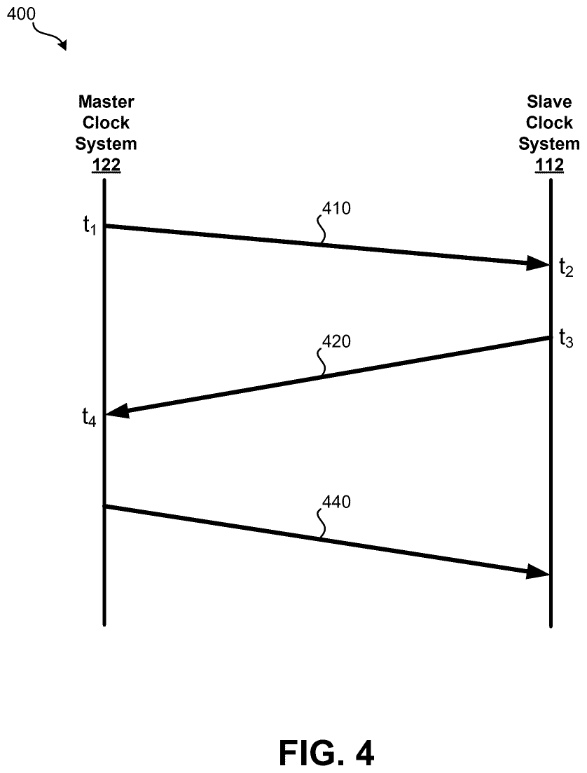

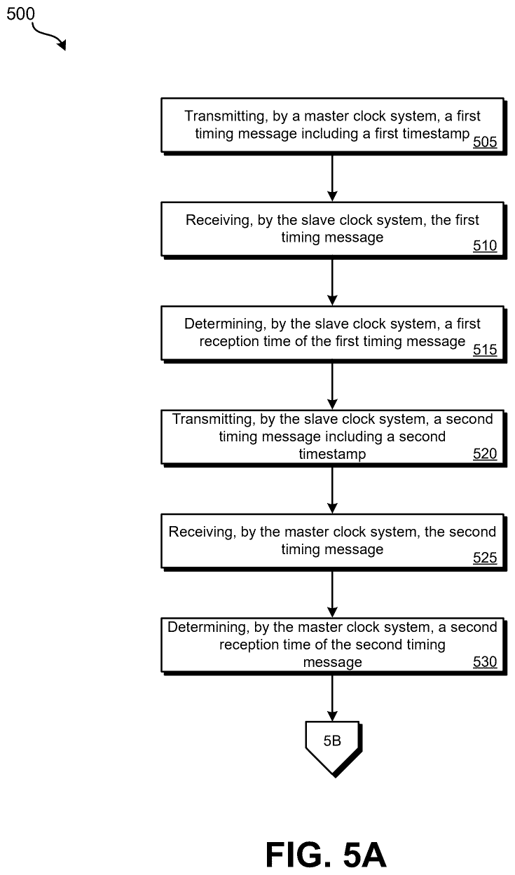

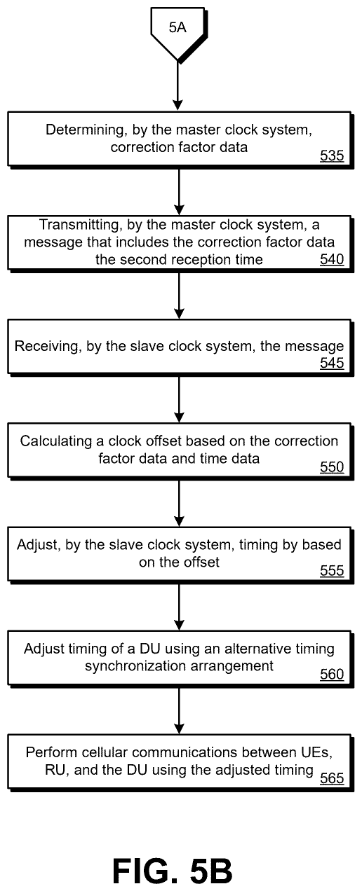

In system 100, timing synchronization can involve multiple messages being exchanged between slave clock system 112 and master clock system 122. When link propagation delay is constant or nearly constant between slave clock system 112 and master clock system 122 (e.g., due to slave clock system 112 and master clock system 122 being at a fixed distance relative to each other), conventional timing arrangements, such as PTP, may be sufficient to perform timing synchronization. However, due to movement of system 110, the link propagation delay can vary quickly and significantly in just the time elapsing during the exchange of the multiple synchronization messages. Therefore, a timing synchronization arrangement as detailed in relation to FIGS. 4, 5A, and 5B can be performed instead.

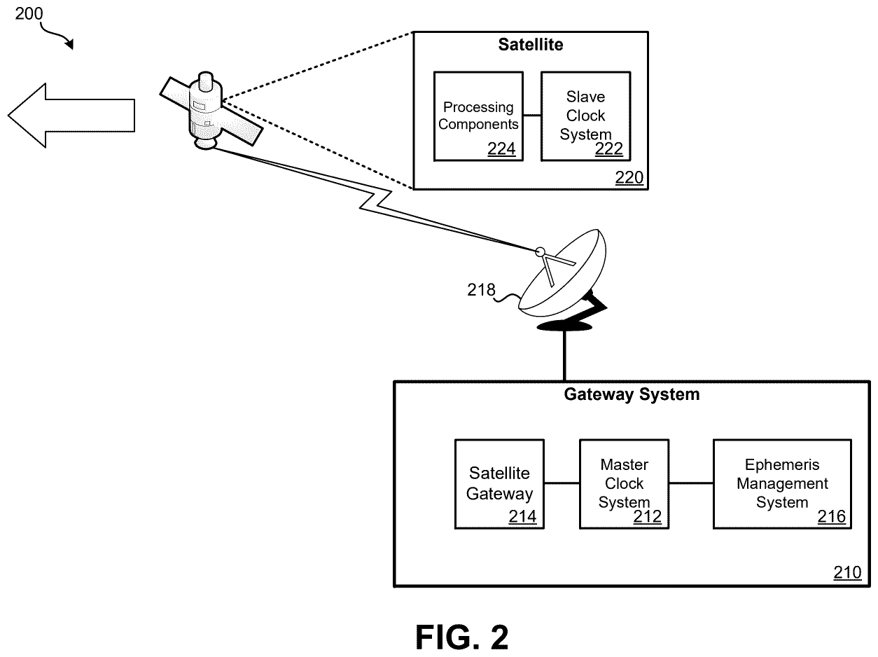

FIG. 2 illustrates an embodiment of a non-terrestrial cellular network system 200 (“system 200”) in which a radio unit is located on a satellite. System 200 can represent a more detailed embodiment of system 100. System 200 can include gateway system 210; satellite antenna 218; and satellite 220. Gateway system 210 can include satellite gateway 214 and master clock system 212. Satellite 220 can include processing components 224 and slave clock system 222. System 200 is specifically directed to an arrangement where a slave clock system located on a satellite needs to be synchronized with a master clock located on the ground. In other embodiments, the locations of the master clock system and the slave clock system can be reversed such that master clock system 122 is located on satellite 220.

In some embodiments, satellite 220 is in LEO or MEO. In LEO, satellite 220 is traveling at a high rate of speed in an orbit above the Earth, typically between about 150 kilometers and 1000 kilometers above the Earth's surface. In other embodiments, satellite 220 can be in geosynchronous orbit (GEO), which involves satellite 220 remaining roughly above a fixed point on the Earth's equator at about 36,000 km above the Earth's surface. A satellite in GEO orbit does tend to move slightly relative to the earth and occasionally needs corrections to their orbit to remain roughly above the same location. MEO is located between GEO and LEO and involves the satellite moving relative to the Earth's surface. Therefore, in LEO or MEO, satellite 220 moves toward or away from gateway system 210, potentially at a high rate of speed.

Gateway system 210, located at a fixed location on Earth, can include satellite gateway 214, which communicates with satellite 220 via satellite antenna 218. One or more components of satellite gateway 214 need to have a synchronized clock with processing components 224 of satellite 220. As illustrated, satellite 220 is moving away from gateway system 210 at a high rate of speed due to satellite 220 being in LEO. Alternatively, satellite 220 can be moving toward gateway system 210 while in LEO.

In system 200, gateway system 210 includes ephemeris management system 216. Ephemeris management system 216 can be implemented using a computer system that stores or has access to data indicative of the orbit of satellite 220. Such data can be an algorithm that accurately provides the location of satellite 220 in orbit based on a provided indication of time. The ephemeris data can be improved over time by measurements of the actual location of the satellite at a given time being used to correct any error in the ephemeris data. Based on the ephemeris data being analyzed based on a precise time, the location of satellite 220 can be determined with a high degree of accuracy. While shown as part of gateway system 210, ephemeris management system 216 can be separate and, possibly, accessible remotely, such as via a public or private network.

Master clock system 212 can access ephemeris management system 216 in order to create a correction factor value that is used in determining a timing offset. In some embodiments, the ephemeris data is retrieved and provided to the system (e.g., slave clock system) that will be calculating the offset. Alternatively, the correction factor value can be calculated by either master clock system 212 or ephemeris management system 216 directly.

In some embodiments, as part of master clock system 212 or ephemeris management system 216, artificial intelligence (AI) or, more specifically as an example, a machine learning (ML) model can be used to further improve the correction factor. For example, over time, based on characteristics of gateway system 210 and satellite 220, and/or the location of satellite 220, adjustments can be applied by a trained ML model to the correction factor or applied in addition to the correction factor. The ML model may have been trained by creating a training set that maps various characteristics to an amount of adjustment that needs to be performed to the calculated offset in addition to the calculated correction factor.

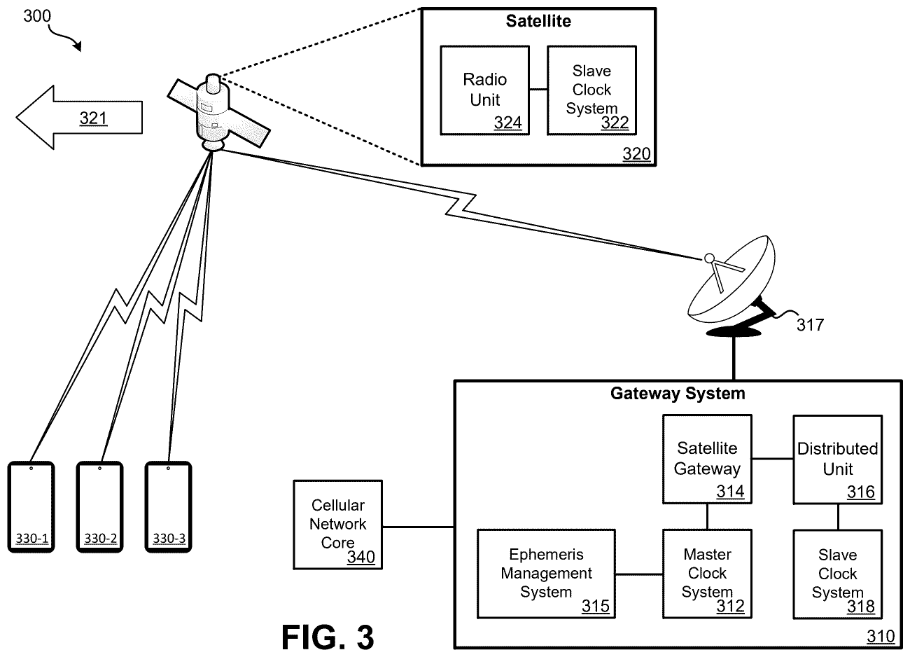

FIG. 3 illustrates an embodiment of a non-terrestrial cellular network system 300 (“system 300”) in which the PTP is used in combination with a timing synchronization arrangement for variable link propagation delay systems. System 300 can represent a more detailed embodiment of system 200 of FIG. 2 and system 100 of FIG. 1. System 300 includes: gateway system 310; satellite antenna 317; satellite 320; UEs 330; and cellular network core 340. In system 300, satellite 320 is in LEO or MEO orbit. As shown, satellite 320 is moving away 321 from gateway system 310 at a high rate of speed. At another time, satellite 320 can be moving toward gateway system 310 at a high rate of speed.

System 300 represents a non-terrestrial 5G New Radio cellular network system in which the RU is located at satellite 320 but the DU is located on the ground, either as part of or in communication with gateway system 310. DU 316 performs various functions, such as performing wireless communication scheduling, for transmissions involving RU 324. In other embodiments, a different type of cellular network, such as 6G, 7G, and beyond may be used in place of 5G NR cellular technology. UEs 330 (330-1, 330-2, and 330-2) represent UEs that communicate with a cellular network, which includes cellular network core 340 via satellite 320. Such UEs 330 may exclusively communicate via a satellite constellation, including satellite 320, to communicate with the cellular network or may be additionally capable of communication with ground-based base stations (e.g., gNBs).

In a 5G NR cellular network, clock synchronization between the RU and its DU is necessary. As such, RU 324 is connected with slave clock system 322 and master clock system 312 is hosted by gateway system 310. Slave clock system 318 functions as the clock for DU 316. Notably, different synchronization arrangements can be used to synchronize the slave clocks for DU 316 and RU 324. Master clock system 312 is maintained separate from DU 316 and RU 324; however, in other embodiments, the master clock (which can be referred to as a timing grandmaster) can be maintained at either satellite 320 or with DU 316. For example, if the master clock is directly used by DU 316, a slave clock can be located at one or more system at gateway system 310 and a slave clock can be located on satellite 320 in communication with RU 324.

As shown, DU 316 is incorporated as part of gateway system 310. In other embodiments, DU 316, along with slave clock system 318 can exist outside of gateway system 310. DU 316 is in communication with a central unit (not illustrated), through which communication with cellular network core 340 is performed. Cellular network core 340 can be hosted by a cloud computing service provider (e.g. Amazon Web Services). Cellular network core 340 can include various functions, such as: network resource management components; policy management components; subscriber management components; and packet control components.

In system 300, the timing synchronization arrangement detailed in relation to FIGS. 4, 5A, and 5B is used to determine a timing offset and synchronize slave clock system 322 with master clock system 312. Ephemeris management system 315 can be included as part of gateway system 310 or can reside outside of gateway system 310 and be accessible by master clock system 312. Ephemeris management system 315 can function as detailed in relation to ephemeris management system 216 of FIG. 2. However, because the link propagation delay between DU 316 and satellite gateway 314 is fixed or relatively fixed (due to both being located at fixed locations), a different timing synchronization arrangement is used, such as PTP. Therefore, PTP can be used for synchronization between master clock system 312 and slave clock system 318.

FIG. 4 illustrates an embodiment of a timing diagram 400 for a variable link propagation delay system. Timing diagram 400 is applicable to master clock system 122 and slave clock system 112, which are applicable to systems 100, 200, and 300 of FIGS. 1, 2, and 3, respectively. The steps performed by the master clock system 122 and slave clock system 112 can be performed in an alternative embodiment. Described below along with timing diagram 400, FIGS. 5A and 5B collectively illustrate an embodiment of method 500 for using a timing synchronization arrangement for a variable link propagation delay system. Method 500 can be performed by systems 100, 200, and 300. Alternatively, method 500 can be performed by some other form of master and slave timing system. As a specific example, method 500 may be used to synchronize clocks for an RU and DU, where the DU resides on the ground and the RU is on-board a satellite, as detailed in relation to FIG. 3.

At block 505, the master clock system transmits a first timing message that includes a first timestamp (t₁) based on the master clock. Since the slave clock is located a distance away from the master clock system, an amount of link propagation delay is present. Additional delay can also be present for the signal to propagate through circuits, amplifiers, waveguide, etc. This first timing message is indicated as message 410.

At block 510, the slave clock system receives the first timing message. An amount of time has elapsed since transmission of the first message. At block 515, a first reception time is determined by the slave clock system for message 410 and stored. The first reception time can be referred to as t₂. Equation 1 details the amount of delay (d₁) and the timing offset (offset) present between the master clock system and the slave clock system.

$${t}_{2} - {t}_{1} = offset + {d}_{1} \qquad Eq . 1$$

At block 520, the slave clock system transmits a second timing message that includes a third timestamp (t₃) based on the slave clock. Since the slave clock is located a distance away from the master clock system, an amount of propagation delay is present. Notably, the amount of delay for the second timing message can differ from the first timing message because the location of the slave clock system (e.g., on a satellite) has meaningfully changed since the first timing message was transmitted. Again, additional delay can also be present for the signal to propagate through circuits, amplifiers, waveguide, etc. This second timing message is indicated as message 420. Equation 2 details the amount of delay (d₂) and the timing offset (offset), which is constant from Equation 1, present between the master clock system and the slave clock system. As noted above, d₁ can differ from d₂.

$${t}_{4} - {t}_{3} = - offset + {d}_{2} \qquad Eq . 2$$

At block 525, the master clock system receives the second timing message. An amount of time has elapsed since transmission of the second message (and which can vary from the amount of time of block 515). At block 530, a second reception time is determined by the master clock system for message 420. The second reception time can be referred to as t₄.

On FIG. 5B, method 500 continues. At block 535, correction factor data is calculated by the master clock component (or some other component, such as an ephemeris management system). The correction factor (CF) is described by Equation 3.

$$CF = {d}_{2} - {d}_{1} \qquad Eq . 3$$

The CF can be calculated by the master clock system (or another component) because the location of the slave clock system with respect to the master clock system is known with a high degree of accuracy. Further, constant link propagation delay (e.g., due to signal propagation through transmission links, amplifiers, and processing components) effectively cancels itself out when Equations 1-3 are combined together for the final offset calculation.

In order to calculate CF, the propagation delay of d₁ is calculated based on where the slave clock system was located at the time of reception at block 510. At the reception time indicated by t₂, data, such as ephemeris data of the satellite is accessed to determine the precise position of the satellite in orbit. The exact distance and associated amount of delay (d₁) due to propagation can then be calculated. The propagation delay of d₂ is calculated based on where the slave clock system was located at the time of transmission of block 520. At the transmission time indicated by t₃, data, such as ephemeris data of the satellite, is accessed to determine the precise position of the satellite in orbit. The exact distance and associated amount of delay (d₂) due to propagation can then be calculated. In some embodiments, the CF value calculated according to Equation 3 can then be further refined using artificial intelligence or an ML model as detailed in relation to ephemeris management system 315.

At block 540, a message can be transmitted by the master clock component to the slave clock component as message 440 that indicates the CF. As part of the same message or part of a separate message, t₄ can be provided to the slave clock system. As such, following block 540, the slave clock system has t₁ (timestamp of timing message 410), t₂ (locally calculated by the slave clock system), t₃ (locally calculated by the slave clock system), and t₄ (transmitted by the master clock system). The message is received by the slave clock system at block 545.

At block 550, the clock offset value is computed according to Equation 4, which is created from Equations 1-3.

$$offset = \frac{{t}_{2} - {t}_{1} + {t}_{3} - {t}_{4} + CF}{2} \qquad Eq . 4$$

While in some embodiments, calculation of the final offset value is performed by the slave clock system, in other embodiments, the values of t₂ and t₃ can be transmitted to the master clock system and used to compute the final offset value at the master clock. In such embodiments, the calculated value of the offset would then be transmitted to the slave clock system.

At block 555, the timing output by the slave clock system is adjusted based on the calculated offset in order to synchronize with the master clock system. In embodiments where the slave clock system is used for the timing of an RU in a 5G cellular arrangement in which the DU is located at or in communication with the satellite gateway, the timing of a slave clock of the DU can be adjusted using another timing synchronization arrangement, such as PTP, at block 560. Using PTP may be sufficient since the delay between the master clock and the slave clock system of the DU is constant or near constant.

At block 565, cellular communications are performed using the system such that the DU and RU, as synchronized according to method 500, are used to provide cellular service to one or more pieces of user equipment.

Method 500 can be repeated often. For example, timing may be synchronized regularly at an interval between 1-30 seconds. In other embodiments, a greater amount of time may elapse between the synchronization process of method 500 being performed.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A non-terrestrial cellular network system, comprising:
a radio unit (RU) located on a satellite configured to orbit the earth;
a slave clock system, comprising a slave clock, located on the satellite, that performs timing for the RU;
a distributed unit (DU), located at a ground station, wherein the ground station communicates wirelessly with the satellite;
a satellite gateway system, comprising a master clock system, wherein the master clock system is configured to:
transmit a first timing message to the slave clock system, wherein the first timing message comprises a first timestamp indicative of a first transmission time;
receive a second timing message from the slave clock system;
record a first reception time at which the second timing message was received from the slave clock system;
calculate a correction factor for the slave clock system located on the satellite; and
transmit a third timing message to the slave clock system that indicates the calculated correction factor and the first reception time.

2. The non-terrestrial cellular network system of claim 1, wherein the correction factor is based on ephemeris data for the satellite.

3. The non-terrestrial cellular network system of claim 1, wherein the correction factor is based on a difference in an amount of link propagation delay for the second timing message and the first timing message.

4. The non-terrestrial cellular network system of claim 1, wherein the slave clock system is configured to:
record a second reception time at which the first timing message was received; and
record a second transmission time at which the second timing message was transmitted by the slave clock system.

5. The non-terrestrial cellular network system of claim 4, wherein the slave clock system is further configured to calculate a timing offset between the slave clock and the master clock system based on: the correction factor, the first transmission time, the second transmission time, the first reception time, and the second reception time.

6. The non-terrestrial cellular network system of claim 5, wherein the slave clock system is further configured to update timing for the RU based on the calculated timing offset.

7. The non-terrestrial cellular network system of claim 1, further comprising:
a second slave clock system, comprising a second slave clock, of the DU, wherein the second slave clock is synchronized with the master clock system using the precision timing protocol (PTP).

8. The non-terrestrial cellular network system of claim 1, wherein the master clock system is further configured to adjust the correction factor using a trained machine learning model.

9. The non-terrestrial cellular network system of claim 2, wherein the master clock system being configured to calculate the correction factor for the RU located on the satellite comprises the master clock system being configured to:
calculate a first link propagation delay for the first timing message from the master clock system to the slave clock system on the satellite based on the ephemeris data;
calculate a second link propagation delay for the second timing message from the slave clock system on the satellite to the master clock system based on the ephemeris data; and
calculating the correction factor based on the first link propagation delay and the second link propagation delay.

10. The non-terrestrial cellular network system of claim 6, wherein the RU is configured to relay cellular network communications between a plurality of UE and the distributed unit based on the updated timing.

11. The non-terrestrial cellular network system of claim 1, wherein the RU on the satellite and the DU located at the satellite gateway system as part of a gNodeB in communication with a core of a 5G New Radio (NR) cellular network.

12. A method for performing timing synchronization in a variable link propagation delay environment, the method comprising:
transmitting, by a master clock system, a first timing message to a slave clock system, wherein:
the first timing message comprises a first timestamp indicative of a first transmission time;
the slave clock system is remotely located from the master clock system; and
wireless communication is used for communication between the slave clock system and the master clock system;
receiving, by the master clock system, a second timing message from the slave clock system;
recording, by the master clock system, a first reception time at which the second timing message was received from the slave clock system;
calculating, by the master clock system, a correction factor; and
transmitting, by the master clock system, a third timing message to the slave clock system that indicates the calculated correction factor and the first reception time.

13. The method of claim 12, wherein the correction factor is based on ephemeris data for a satellite that houses the slave clock system.

14. The method of claim 12, wherein the correction factor is based on a difference in an amount of link propagation delay for the second timing message and the first timing message.

15. The method of claim 12, further comprising:
recording, by the slave clock system, a second reception time at which the first timing message was received; and
recording a second transmission time at which the second timing message was transmitted by the slave clock system.

16. The method of claim 15, further comprising:
calculating, by the slave clock system, a timing offset between the slave clock system and the master clock system based on: the correction factor, the first transmission time, the second transmission time, the first reception time, and the second reception time.

17. The method of claim 16, further comprising:
updating, by the slave clock system, timing based on the calculated timing offset.

18. The method of claim 12, further comprising:
synchronizing, the master clock system with a second slave clock, using the precision timing protocol (PTP).

19. The method of claim 13, wherein calculating the correction factor comprises:
calculating a first link propagation delay for the first timing message from the master clock system to the slave clock system based on the ephemeris data;
calculating a second link propagation delay for the second timing message from the slave clock system to the master clock system based on the ephemeris data; and
calculating the correction factor based on the first link propagation delay and the second link propagation delay.

20. The method of claim 19, wherein the slave clock system is co-located on the satellite with a radio unit (RU) of a gNodeB and the master clock system is co-located at a satellite gateway with a distributed unit (DU) of the gNodeB.
